(19) United States
(12) Patent Application Publication
(10) Pub. No.: US 2002/0038241 A1
(43) Pub. Date: Mar. 28, 2002

(54) Method of and apparatus for providing points by relating keyword retrieval to advertising, and computer product

(76) Inventor: Masaki Hiraga, Kawasaki (JP)

Correspondence Address: STAAS & HALSEY LLP, 700 11TH STREET, NW, SUITE 500, WASHINGTON, DC, 20001, US

(21) Appl. No.: 09/839,138

(22) Filed: Apr. 23, 2001

(30) Foreign Application Priority Data
Sep. 27, 2000 (JP) 2000-295281

(51) Int. Cl. G06F 17/60

(52) U.S. Cl. 705/14

(57) ABSTRACT

Keywords obtained by the users and keywords obtained by the advertisers are registered in management tables respectively. When users different from the registered users have retrieved the keyword by making access to the server, retrieved results and advertisement of the advertisers registered in the management tables are posted to these users. When the other users have referred to the advertisement, points are given to the users who have registered the keywords.

### FIELD OF THE INVENTION

The present invention relates to the Internet, and relates, more particularly, to retrieval and an advertising service utilizing the Internet.

### BACKGROUND OF THE INVENTION

Various services have been proposed relating to retrieval services and advertising businesses that utilize the Internet, and these services and businesses have been actually applied. Among them, there have come to be created new services that provide a new added value by relating a conventional advertising business to a retrieval service that is different from a mere keyword retrieval service.

Among such retrieval services and advertising businesses that utilize the Internet, a business of selling a retrieval keyword itself that is linked to an advertising display has been started as the retrieval service in the USA and Japan.

For example, Alta Vista and Double Click in the USA have started a service of auctioning a retrieval keyword and making a display of a link to the site obtained by a successful bidding, with a priority set this site over other sites.

In Japan, Cyber Agent and On the Edge have started respectively services of acquiring a priority display frame for keywords that advertisers want, and displaying the sites of advertisers at high rank in the retrieved results.

As explained above, the services of selling a retrieval keyword itself that is linked to the advertising display have already been developed in the retrieval service. However, the services provided at present have been closed to service providers (including companies that provide the services and service providers) and enterprises (advertisers). End users are not able to participate in these services.

### SUMMARY OF THE INVENTION

It is an object of the present invention to provide a method and apparatus that enables the service providers to further expand their businesses based on a system of an end-user participation type business that adds further values to the retrieval keywords and that involves end users. It is another object of this invention to provide a computer readable recording medium that stores a computer program which when executed realizes the method according to the present invention.

According to the present invention, a server presents a keyword to a user via the network. The server registers the keyword obtained by the user into a user-by-keyword management table by relating this keyword to the user. Similarly, the server provides a keyword to an advertiser via the network. The server registers the keyword obtained by the advertiser into an advertiser-by-keyword management table by relating this keyword to the advertiser.

When a user different from the above user has searched using the keyword that has been registered in the user-by-keyword management table and the advertiser-by-keyword management table respectively through the network, the server displays the advertising of the advertiser relating to this keyword at the user terminal. When this user has referred to this advertising, the server gives points to the user who has registered this keyword.

The user who has gained the points can obtain a product or a commercial service in exchange for these points.

The computer readable recording medium according to another aspect of the present invention stores a computer program which when executed realizes the method according to the present invention.

Other objects and features of this invention will become apparent from the following description with reference to the accompanying drawings.

### BRIEF DESCRIPTION OF THE DRAWINGS

FIG. 1 is a block structure diagram of a system relating to an embodiment of the present invention;

FIG. 2 is a diagram for explaining a structure of a server;

FIG. 3 is a diagram showing an example of a keyword table having ranked keywords;

FIG. 4 is a diagram showing an example of a table of charged keywords;

FIG. 5 is a diagram showing an example of a table of free keywords;

FIG. 6 is a diagram showing an example of an advertiser-by-charged-keyword management table;

FIG. 7 is a diagram showing an example of an advertiser-by-free-keyword management table;

FIG. 8 is a diagram showing an example of an advertiser management table;

FIG. 9 is a diagram showing an example of a user-by-charged-keyword management table;

FIG. 10 is a diagram showing an example of a user-by-free-keyword management table;

FIG. 11 is a diagram showing an example of user management table;

FIG. 12 is a diagram showing an example of a user's-point management table;

FIG. 13 is a diagram showing an example of a user-product-exchange management table;

FIG. 14 is a flowchart for explaining a processing of the total system;

FIG. 15 is a flowchart for explaining a processing of generating a keyword;

FIG. 16 is a flowchart for explaining a processing of selling user management tables for advertisers;

FIG. 17 is a flowchart for explaining a processing of registering free keywords for advertisers;

FIG. 18 is a flowchart for explaining a processing of registering free keywords for users;

FIG. 19 is a flowchart for explaining a processing of selling user management table for users;

FIG. 20 is a flowchart for explaining a retrieval/advertising presentation processing;

FIG. 21 is a flowchart for explaining a settlement processing;

FIG. 22 is a flowchart for explaining a product exchange processing;

FIG. 23 is a flowchart for explaining a keyword reevaluation processing; and

FIG. 24 is a flowchart for explaining a keyword transfer-selling processing.

### DESCRIPTION OF THE PREFERRED EMBODIMENTS

Preferred embodiment of the present invention will be explained in detail below with reference to the accompanying drawings.

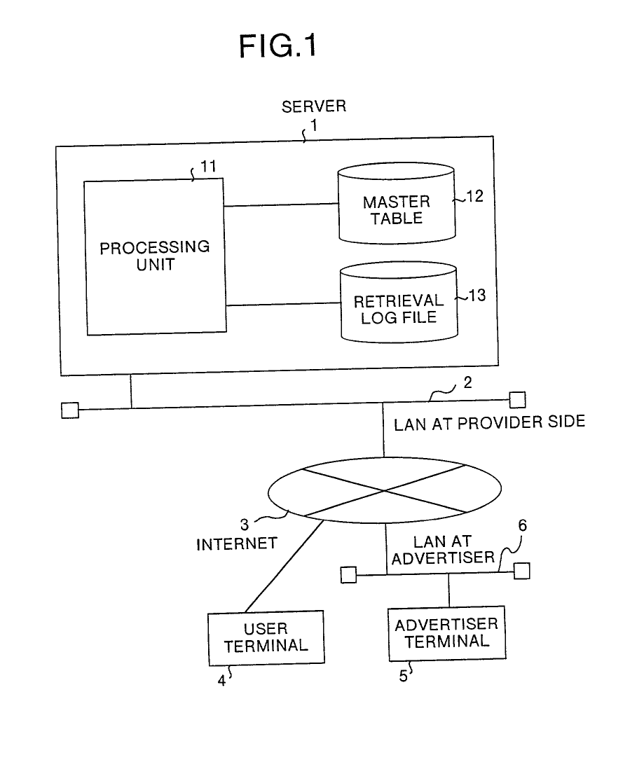

FIG. 1 is a block diagram showing a system structure of the apparatus according to the present invention. Reference numeral 1 denotes a server of a provider, reference numeral 2 denotes a LAN (Local Area Network) at the provider side, reference numeral 3 denotes the Internet, reference numeral 4 denotes a user terminal (i.e. a terminal located at the user side), reference numeral 5 denotes an advertiser terminal (i.e. a terminal located at the office of the advertising agency), and reference numeral 6 denotes a LAN at the advertiser side.

The server 1 includes a processing unit 11, a master table 12, and a retrieval log file 13, and is connected to the Internet 3 through the provider-side LAN 2.

The user terminal 4 is connected to the Internet 3, and makes access to the server 1 through the Internet 3 and the provider-side LAN 2.

The user can make request to the server 1 for a keyword registration and retrieval, by inputting a keyword from the user terminal 4.

The advertiser terminal 5 is connected to the Internet 3 through the advertiser-side LAN 6, and is accessed by the server 1 through the advertiser-side LAN 6 the Internet 3 and the provider-side LAN 2.

The advertiser can make request to the server 1 for a keyword registration and an advertising registration, by inputting a keyword and advertising data from the advertiser terminal 5.

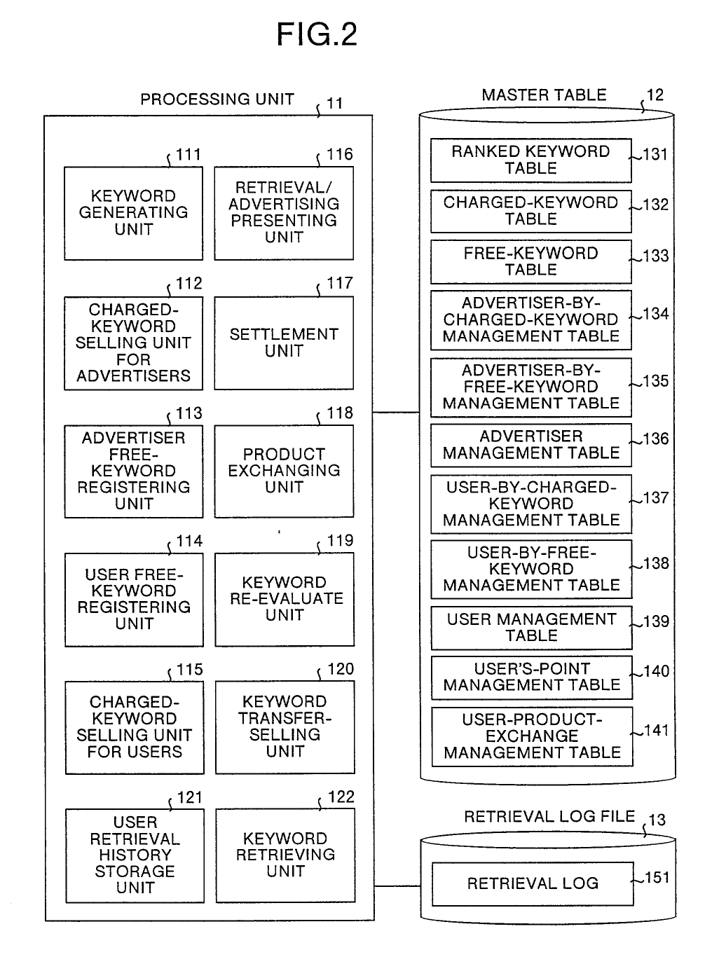

FIG. 2 is a diagram for explaining a structure of the processing unit 11, the master table 12, and the retrieval log file 13 within the server 1.

The processing unit 11 is provided with keyword generating unit 111, charged-keyword selling unit for advertisers 112, advertiser free-keyword registering unit 113, user free-keyword registering unit 114, charged-keyword selling unit for users 115, retrieval/advertising presenting unit 116, settlement unit 117, product exchanging unit 118, keyword re-evaluating unit 119, keyword transfer-selling unit 120, user retrieval history storage unit 121, and keyword retrieving unit 122.

The master table 12 is provided with a ranked keyword table 131, a table of charged keywords 132, a table of free keywords 133, a advertiser-by-charged-keyword management table 134, a advertiser-by-free-keyword management table 135, an advertiser management table 136, a user-by-charged-keyword management table 137, a user-by-free-keyword management table 138, a user management table 139, a user's-point management table 140, and a user-product-exchange management table 141.

The retrieval log file 13 stores a retrieval log 151.

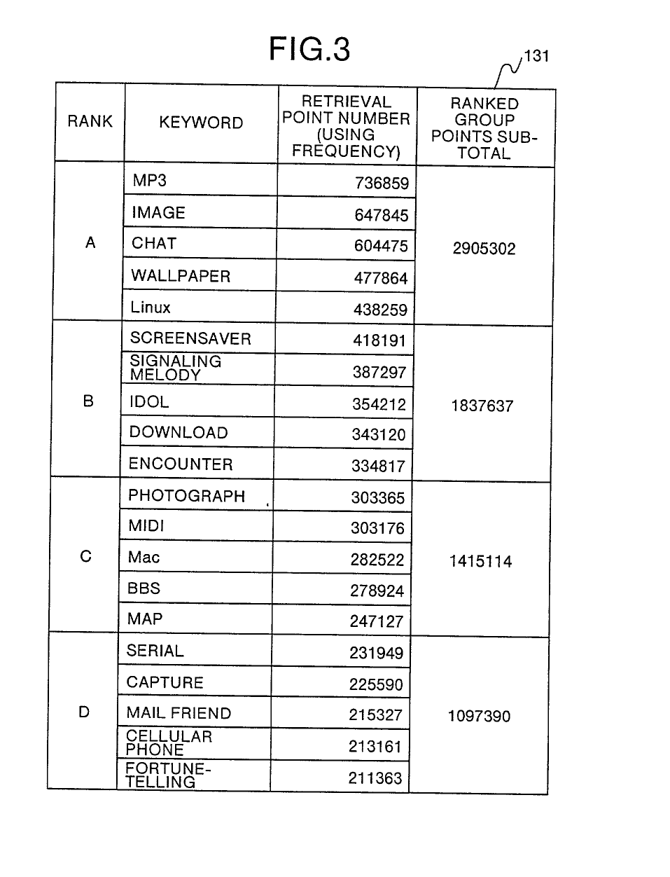

Detailed contents of each table within the master table 12 will be explained next with reference to FIG. 3 to FIG. 13.

FIG. 3 is a diagram showing an example of the ranked keyword table 131. This ranked keyword table 131 includes retrieval point numbers that show using frequencies (retrieval frequency) of keywords. The keyword generating unit 111 sorts the keywords and ranks them in the order of high retrieval frequency based on the retrieval log 151 in the retrieval log file 13 that stores a result of the keyword retrieval service.

In this case, the retrieval point corresponds to the using frequency of a keyword. In the present embodiment, there are twenty retrieval keywords in total. These retrieval keywords are classified into four groups from rank A to D, each having five keywords, in the order of high retrieval points. The keyword generating unit 111 sets the total of the point numbers for each rank group as a sub-total of point numbers by rank.

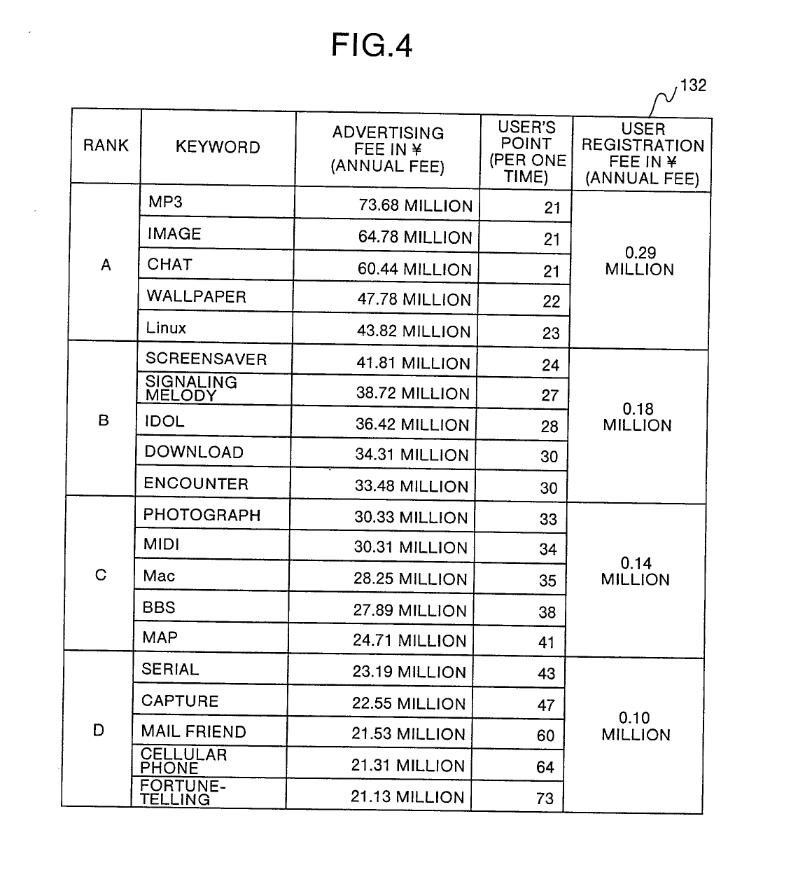

FIG. 4 is a diagram showing an example of the table of charged keywords 132.

In FIG. 4, the table of charged keywords 132 stores ranks, keywords, advertising fees, user's points, and user registration fees, by relating them to each other.

The correspondence between the ranks and the keywords is based on the above keyword table 131. The keyword generating unit 111 sets the advertising fees, the user's points, and the user registration fees for each keyword based on the past result of using frequencies.

The advertising fee for each keyword is based on the past result of using frequency. In the present embodiment, one point of the retrieval point shown in FIG. 3 is calculated as 100 yen.

The user's point for each keyword is obtained by allocating the values of one to the ten thousands of the respective retrieval point numbers to each keyword in the opposite order.

The annual user registration fee is calculated as 0.1 yen per one point of each sub-total of point numbers by rank shown in FIG. 3.

The number of advertisers invited is determined based on the size of the screen displayed at the user terminal (advertising effect) and the like. For example, the number of advertisers invited is limited to three companies per one keyword. The number of advertisers is not limited to three, and this can be increased or decreased by taking into account the advertising effect. The number of users is not particularly limited as described in detail later.

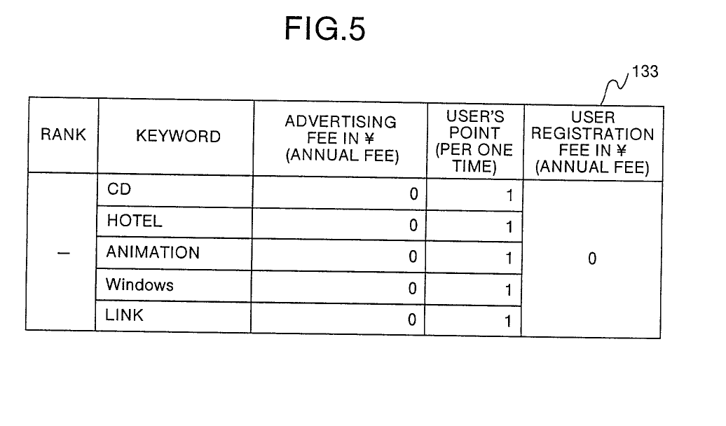

FIG. 5 is a diagram showing an example of the table of free keywords 133.

The table of free keywords 133 also stores ranks, keywords, advertising fees, user's points, and user registration fees (free of charge in this case), by relating them to each other, like the table of charged keywords 132.

The keywords shown here are the keywords that have not been ranked A to D based on the past result of using frequencies.

As the keywords are the free keywords, the advertising fees and user registration fees are set to zero yen, and the user's points are all set as all one point. As the user registration fee is zero yen, it is possible to omit this column from the table. However, there can be a change from a charged keyword to a free keyword and vice versa as described later. Therefore, usually this table of free keywords is prepared in a similar format to that of the table of charged keywords 132.

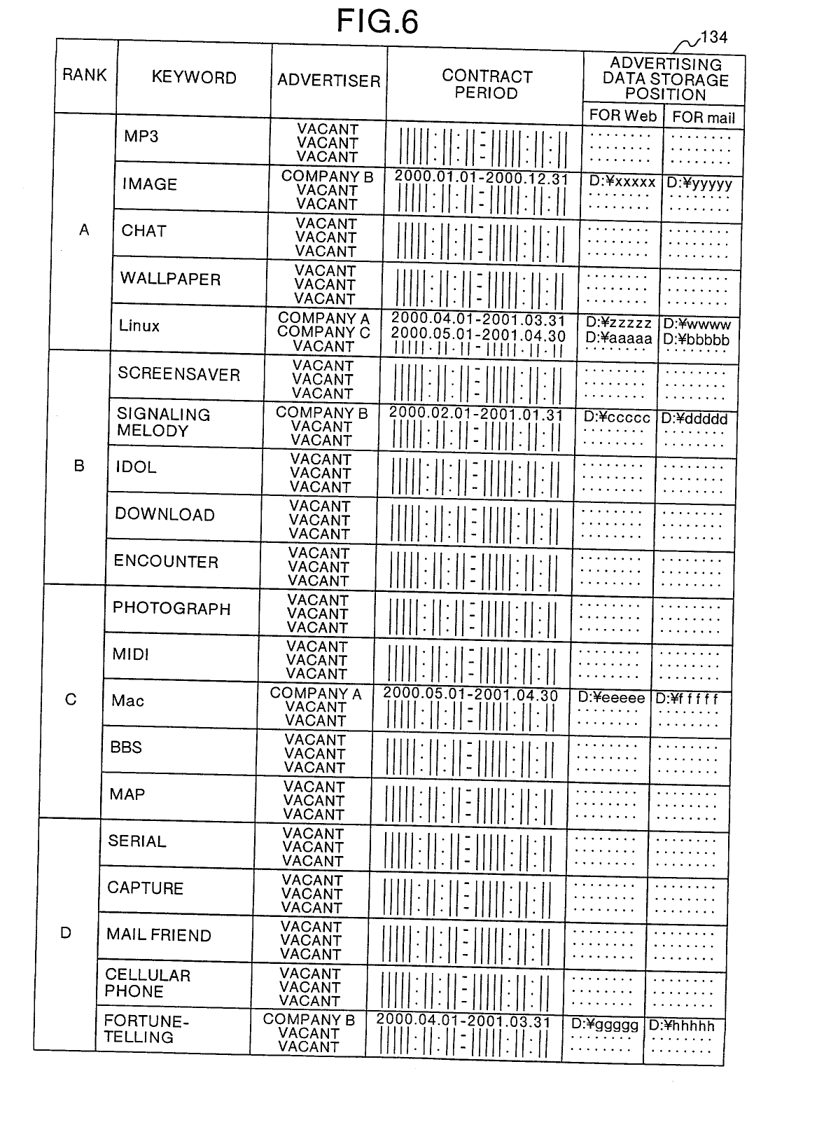

FIG. 6 is a diagram showing an example of the advertiser-by-charged-keyword management table 134.

The advertiser-by-charged-keyword management table 134 shows the contents of a contract between the advertiser and the provider, and the contents of management based on this contract. The charged-keyword selling unit for advertisers 112 sets ranks, keywords, advertisers, contract periods, and advertising data storage positions (for the Web and for mail) in the advertiser-by-charged-keyword management table 134.

The number of advertisers is limited (three companies, for example). The contract period and the advertising data storage position of each keyword are identified. As methods of advertising, there are a method of advertising based on the Web and a method of advertising based on mails. An advertiser can select in advance one of these methods whichever is considered effective based on the advertising contents. Alternately, both methods may be stored for a user to select any one method. In the present embodiment, an explanation is made based on the assumption that a user can select a method.

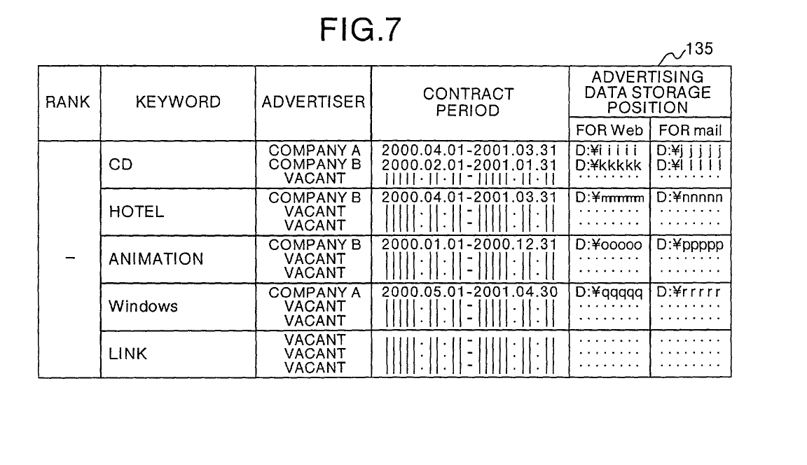

FIG. 7 is a diagram showing an example of the advertiser-by-free-keyword management table 135.

The advertiser-by-free-keyword management table 135 is also set based on a similar format to that of the advertiser-by-charged-keyword management table 134. Therefore, the advertiser-by-free-keyword management table 135 is provided with keywords that are out of the ranks A to D, advertisers, and an advertising storage position (for the Web and for mail).

The advertiser free-keyword registering unit 113 sets these items in the advertiser-by-free-keyword management table 135. However, advertisers who can register free keywords are limited to only advertisers who have purchased charged keywords. Therefore, the advertisers are set based on the assumption that they have already purchased the charged keywords.

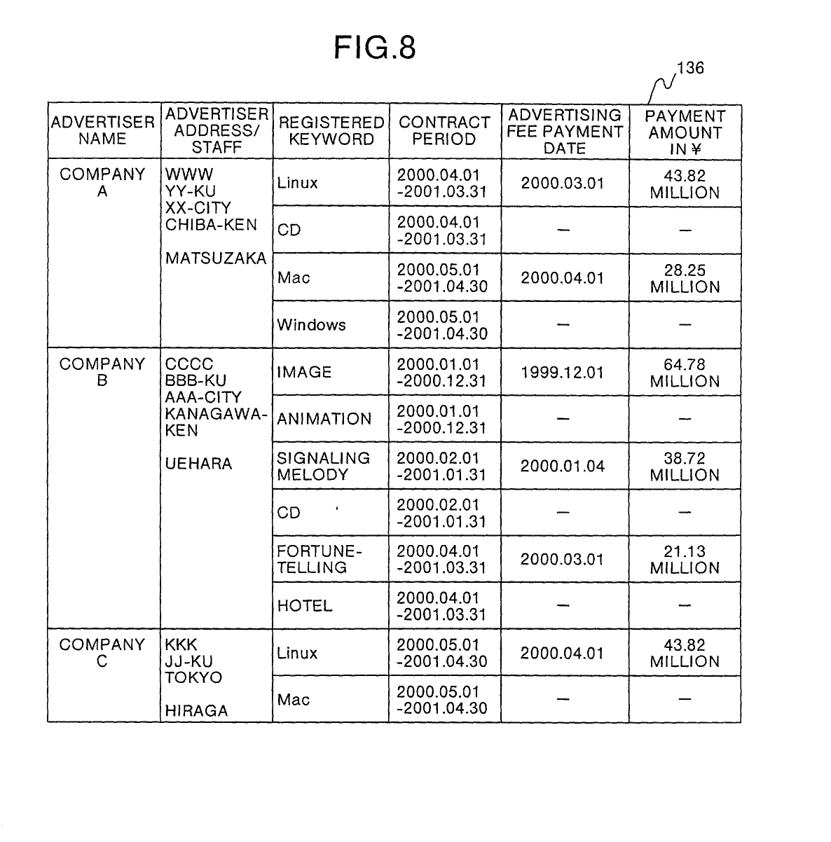

FIG. 8 is a diagram showing an example of the advertiser management table 136.

The advertiser management table 136 stores names of advertisers, advertiser addresses/staffs, registered keywords, contract periods, advertising fee payment dates, and payment amounts by relating them to each other. When the keywords are charged keywords, the charged-keyword selling unit for advertisers 112 sets these items to this table. When the keywords are free keywords, the advertiser free-keyword registering unit 113 sets these items to this table. However, in the case of the free keywords, the payment amounts and the advertising fee payment dates are not set. As explained above, the free keywords are based on the assumption that the advertisers have purchased the charged keywords.

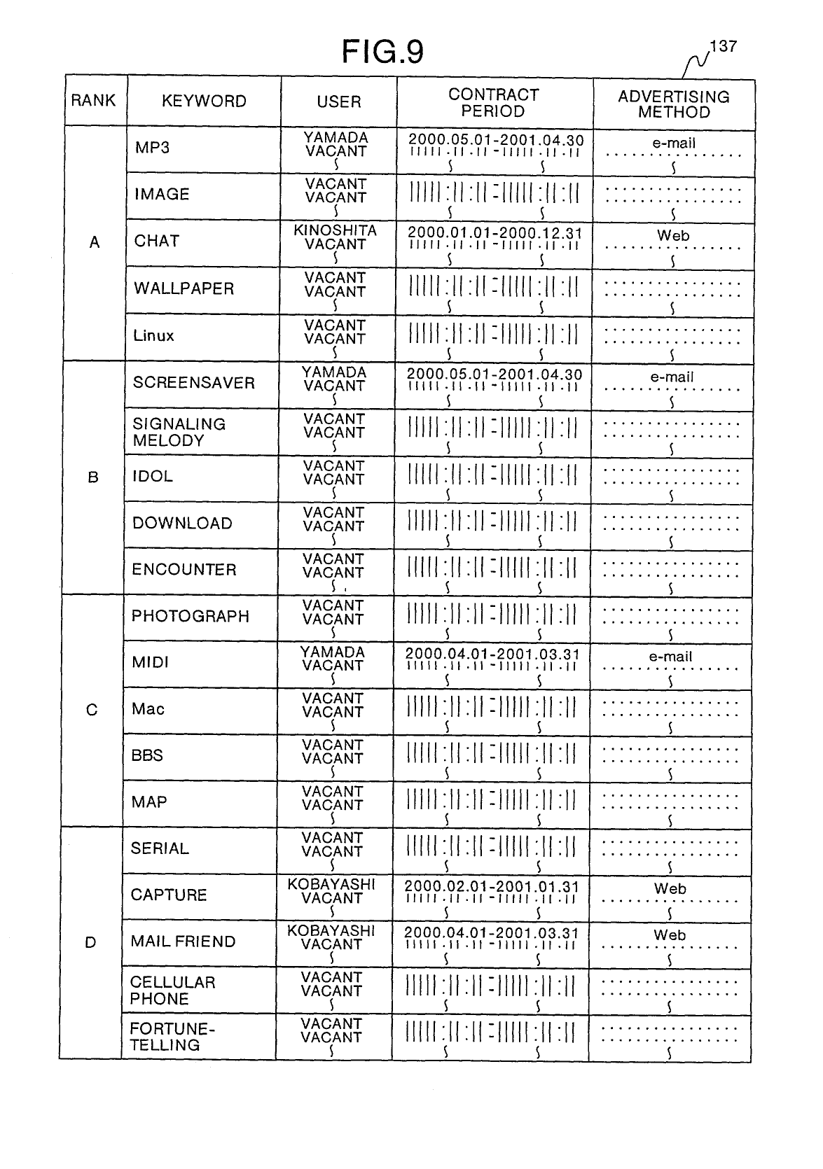

FIG. 9 is a diagram showing an example of the user-by-charged-keyword management table 137.

In FIG. 9, the user-by-charged-keyword management table 137 stores ranks, keywords, users, contract periods, and advertising presentation methods (e-mails/Web). The charged-keyword selling unit for users 115 sets these items to this table based on the contracts between the users and the provider and the contents of management based on these contracts.

A user who has registered first can select an advertising presentation method of either advertising is sent to the user by e-mail or the advertising is displayed on the Web. As described before, when the advertiser has determined the presentation method in advance, users need not select the presentation method.

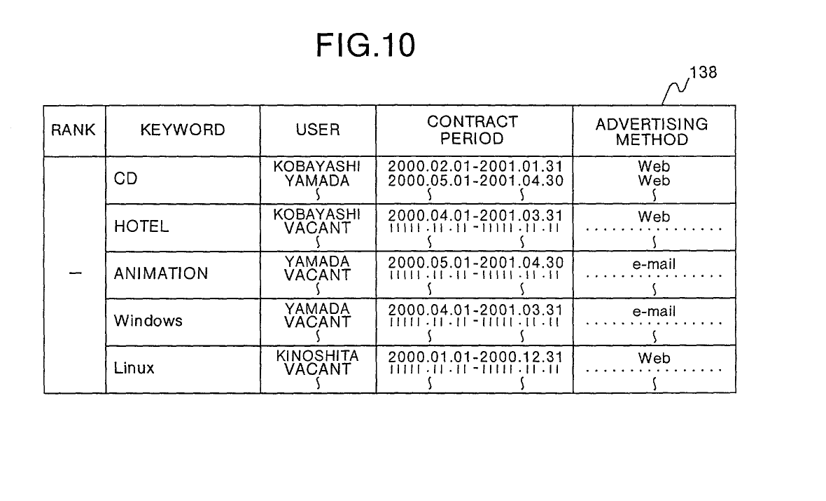

FIG. 10 is a diagram showing an example of the user-by-free-keyword management table 138.

In FIG. 10, the user-by-free-keyword management table 138 stores keywords that are out of ranks, users, contract periods, and advertising presentation method (e-mail/Web) by relating them to each other. The user free-keyword registering unit 114 sets these items to the table based on the contracts of service utilization between the users and the provider respectively.

User registration of free keywords is provided as free of charge. Users can register free keywords without the need for registration of charged keywords unlike the registration carried out by advertisers. In the present embodiment, a user who has registered first can select an advertising presentation method of either an advertising is sent to the user by e-mail or the advertising is displayed on the Web, like in the case of the charged keywords. Users who have registered at the second time or later follow the method determined by the first-registered user.

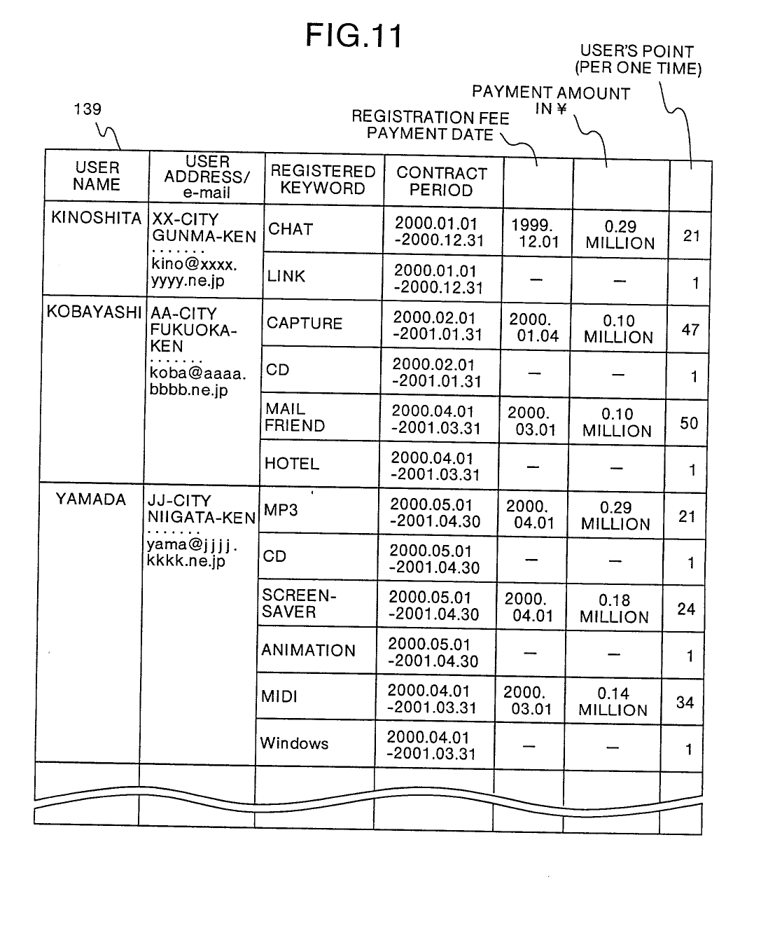

FIG. 11 is a diagram showing an example of the user management table 139.

In FIG. 11, the user management table 139 stores user names, user addresses/e-mail (addresses), registered keywords, contract periods, registration fee payment dates, payment amounts, and user points, by relating them to each other.

In the case of charged keywords, the charged-keyword selling unit for users 115 sets the user points (per one time) of the table of charged keywords 132 to respective users based on the contents of contracts between the users and the provider. In the case of free keywords, the user free-keyword registering unit 114 sets the user points (per one time) of the table of free keywords 133 to respective users based on the contents of contracts between the users and the provider.

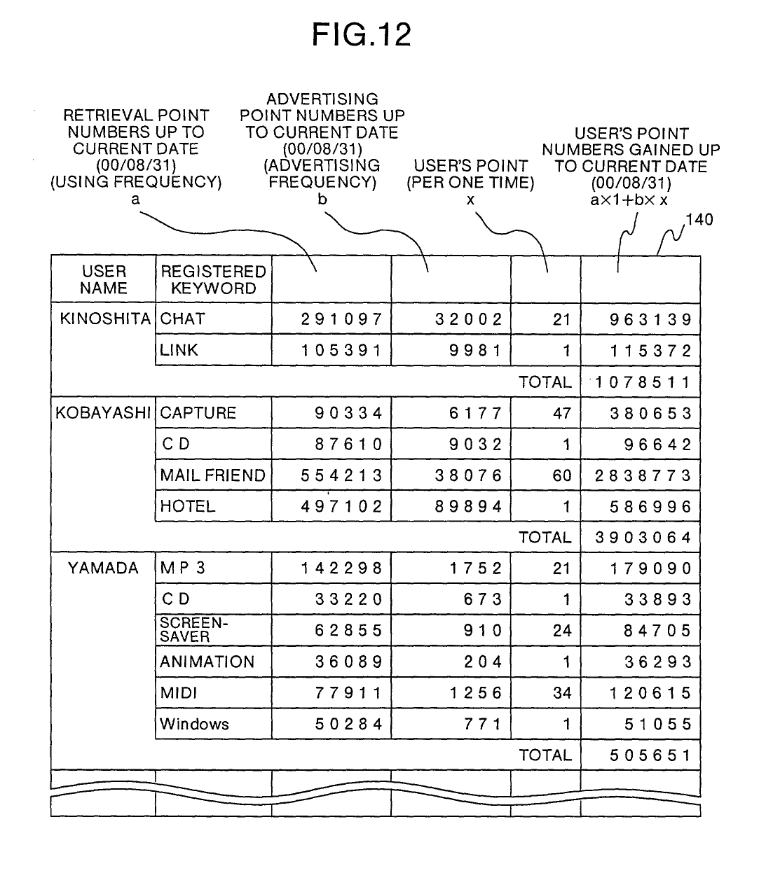

FIG. 12 is a diagram showing an example of the user's-point management table 140.

In FIG. 12, the user's-point management table 140 stores user names, registered keywords, retrieval point numbers (used frequencies) up to the current date (for example, Aug. 31, 2000 (00/08/31)) [a], advertising point numbers (numbers of reference to the advertising) up to the current date (for example, 00/08/31) [b], user's points (per one time) [x], and total user's point numbers [a×1+b ×x] gained up to the current date (for example, 00/08/31), by relating them to each other.

Users can obtain (exchange) various products and services based on the total user points gained.

In the present embodiment, the sum of the retrieval point numbers and the advertising point numbers as the gained user point numbers. It is also possible to arrange such that only the retrieval point numbers or the advertising point numbers becomes the user point numbers.

It is not always necessary to exchange one user point for one yen, and it is possible to optionally set the exchange rate. The provider can adjust the exchange rate to match the values of products and services based on their income of advertising fees from the companies (advertisers) and user registration fees.

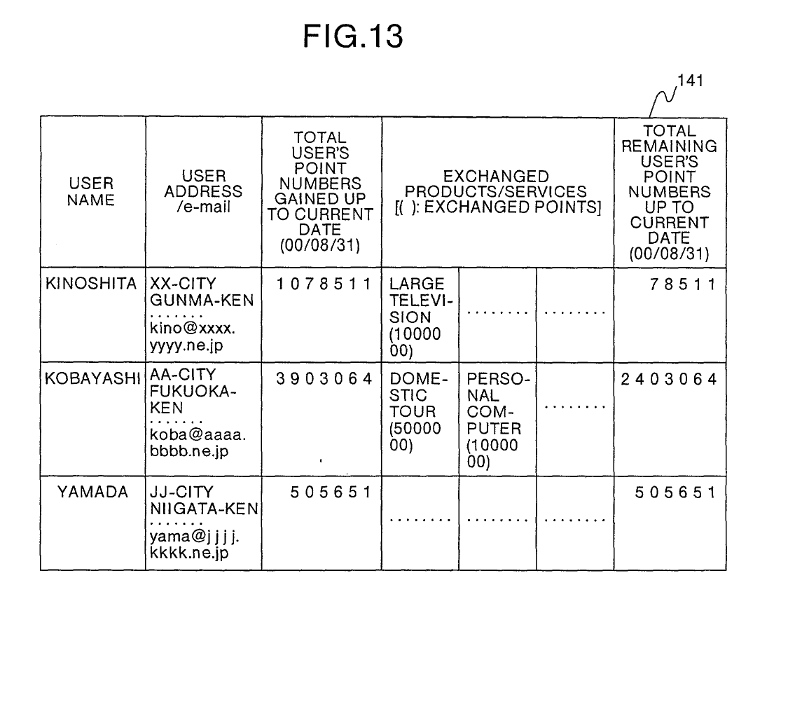

FIG. 13 is a diagram showing an example of the user-product-exchange management table 141.

In FIG. 13, the user-product-exchange management table 141 stores user names, user addresses/e-mail (addresses), total user point numbers gained up to the current date (for example, Aug. 31, 2000 (00/08/31)), products/services exchanged (product exchange point numbers), and total user point numbers up to the current date (for example, 00/08/31), by relating them to each other.

It is possible to inform the users of the remaining total user points after the product exchange by e-mail or postal mail.

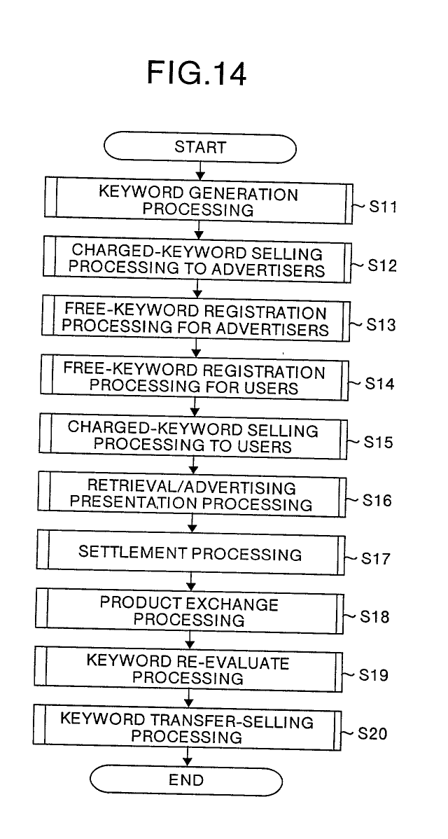

FIG. 14 is a flowchart for explaining the processing of the total system according to the present embodiment.

First, at step S11, a keyword generation processing is carried out.

Next, at step S12, a charged-keyword selling processing to advertisers is carried out.

Next, at step S13, a fee-keyword registration processing for advertisers is carried out.

Next, at step S14, a free-keyword registration processing for users is carried out.

Next, at step S15, a charged-keyword selling processing to users is carried out.

Next, at step S16, a retrieval/advertising presentation processing is carried out.

Next, at step S17, a settlement processing is carried out.

Next, at step S18, a product exchange processing is carried out.

Next, at step S19, a keyword revaluation processing is carried out.

Last, at step S20, a keyword transfer-selling processing is carried out.

In this case, the charged-keyword selling processing to advertisers is carried out first, and then, the free-keyword registration processing for advertisers is carried out. This is because, for an advertiser to obtain a free keyword, the advertiser must obtain a charged keyword beforehand.

Further, the free-keyword registration processing for users is carried out first, and then, the charged-keyword selling processing to users is carried out. This is because the free keyword registration for a user is carried out first as a fee-of-charge service. Based on this, the incentive of a charged keyword registration is given to the user. Therefore, it is preferable that the free keyword processing is registered at the same time when the user makes a contract with the provider.

When such an incentive is not necessary, it is of course possible to replace the order of step S14 with step S15.

Further, it is also possible to replace the processing for the advertisers (steps S12 and S13) with the processing for the users (steps S14 and S15).

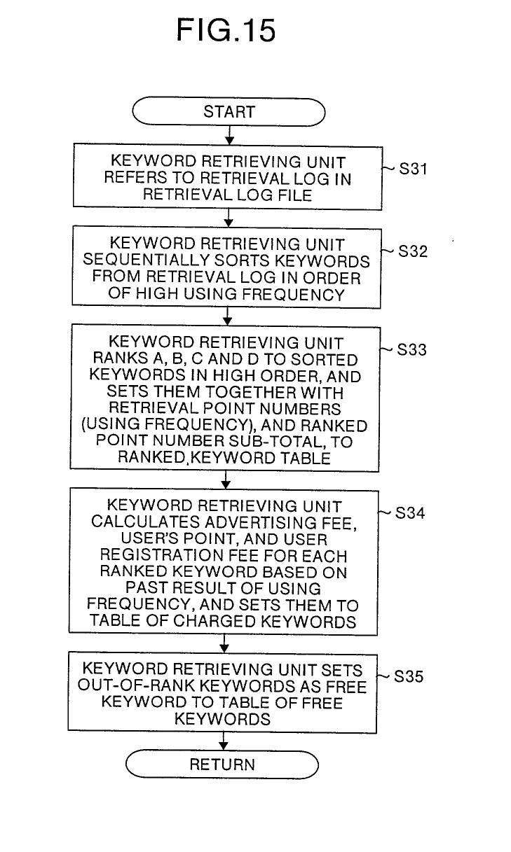

Next, each step of the processing flow in FIG. 14 will be explained with reference to FIG. 15 to FIG. 24.

FIG. 15 is a flowchart for explaining the keyword generation processing by the keyword generating unit 111.

First, at step S31, the keyword generating unit 111 refers to the retrieval log 151 in the retrieval log file 13.

Next, at step S32, the keyword generating unit 111 retrieves keywords from this log, and sorts the keywords in the order of high using frequency.

Next, at step S33, the keyword generating unit 111 ranks the keywords with A, B, C and D in the order of high using frequency, and sets the ranked keywords together with retrieval point numbers (using frequencies), and point number sub-totals by ranks, to the ranked keyword table 131.

Next, at step S34, the keyword generating unit 111 calculates an advertising fee, a user point, and a user registration fee, for each ranked keyword, based on the past using frequency, and sets the calculated result to the table of charged keywords 132.

Next, at step S35, the keyword generating unit 111 sets keywords that are out of ranks to the table of free keywords 133 as free keywords.

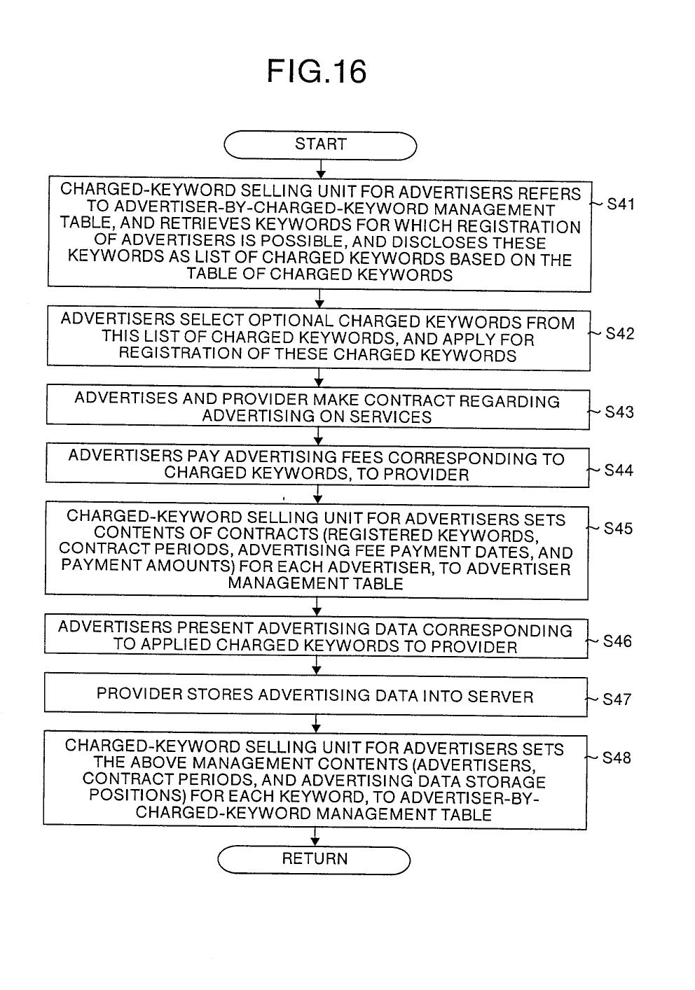

FIG. 16 is a flowchart for explaining the charged-keyword selling processing to advertisers by the charged-keyword selling unit for advertisers 112.

First, at step S41, the charged-keyword selling unit for advertisers 112 refers to the advertiser-by-charged-keyword management table 134, and retrieves keywords for which the registration of advertisers is possible (that is, the number of advertiser has not reached the limit number yet). The charged-keyword selling unit for advertisers 112 then discloses these keywords as a list of charged keywords based on the table of charged keywords 132.

Next, at step S42, advertisers select optional charged keywords from the list of the charged keywords, and apply for the registration of the charged keywords.

Next, at step S43, the advertisers and the provider make contracts regarding the advertising on services.

Next, at step S44, the advertisers pay the advertising fees corresponding to the charged keywords to the provider.

Next, at step S45, the charged-keyword selling unit for advertisers 112 sets the contents of the contracts (registered keywords, contract periods, advertising fee payment dates, and payment amounts) for each advertiser, to the advertiser management table 136.

Next, at step S46, the advertisers present advertising data corresponding to the applied charged keywords to the provider.

Next, at step S47, the provider stores the advertising data into the server.

Next, at step S48, the charged-keyword selling unit for advertisers 112 sets the above management contents (advertisers, contract periods, and advertising data storage positions) for each keyword, to the advertiser-by-charged-keyword management table 134.

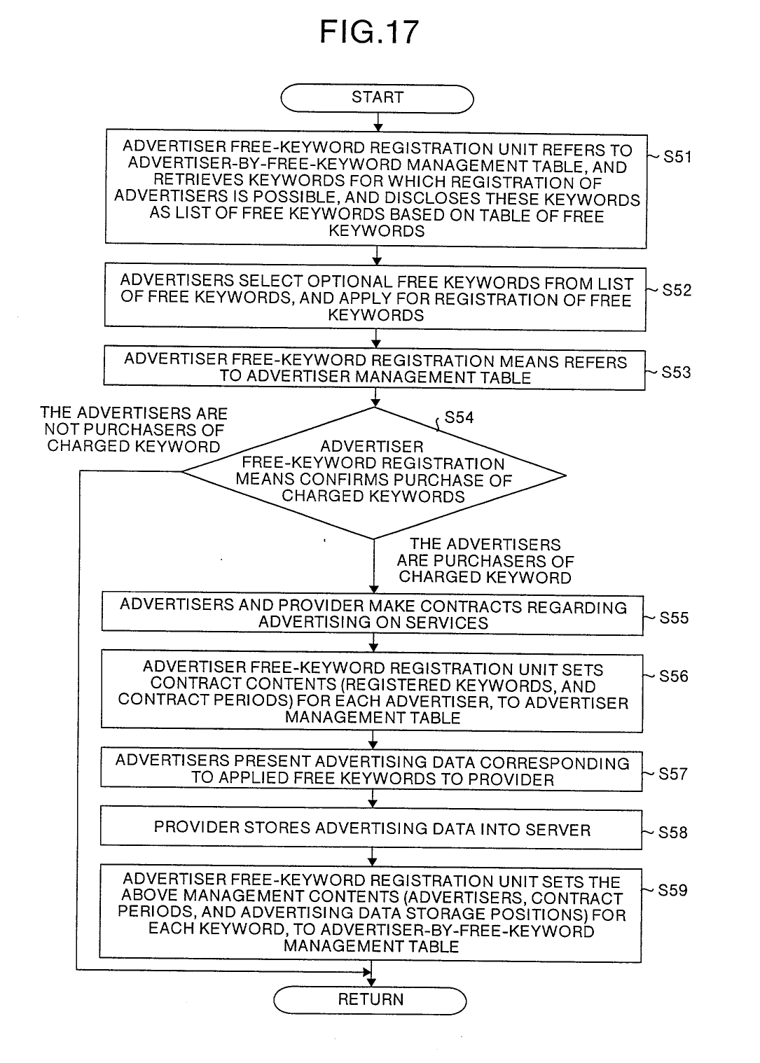

FIG. 17 is a flowchart for explaining the free-keyword registration processing for advertisers by the advertiser free-keyword registering unit 113.

In FIG. 17, first, at step S51, the advertiser free-keyword registering unit 113 refers to the advertiser-by-free-keyword management table 135, and retrieves keywords for which the registration of advertisers is possible (that is, the number of advertiser has not reached the limit number yet). The advertiser free-keyword registering unit 113 then discloses these keywords as a list of free keywords based on the table of free keywords 133.

Next, at step S52, advertisers select optional free keywords from the list of the free keywords, and apply for the registration of the free keywords.

Next, at step S53, the advertiser free-keyword registering unit 113 refers to the advertiser management table 136.

Next, at step S54, the advertiser free-keyword registering unit 113 confirms the presence or absence of the purchase of the charged keywords based on the advertiser management table 136. When the advertisers are not the purchasers of the charged keywords, the registration is not admitted. Therefore, the present processing finishes. When the advertisers are the purchasers of the charged keywords, the process proceeds to step S55.

Next, at step S55, the advertisers and the provider make contracts regarding the advertising on services.

Next, at step S56, the advertiser free-keyword registering unit 113 sets and updates the contract contents (registered keywords, and contract periods) for each advertiser, to the advertiser management table 136.

Next, at step S57, the advertisers present advertising data corresponding to the applied free keywords to the provider. Next, at step S58, the provider stores the advertising data into the server.

Next, at step S59, the advertiser free-keyword registering unit 113 sets the above management contents (advertisers, contract periods, and advertising data storage positions) for each keyword, to the advertiser-by-free-keyword management table 135.

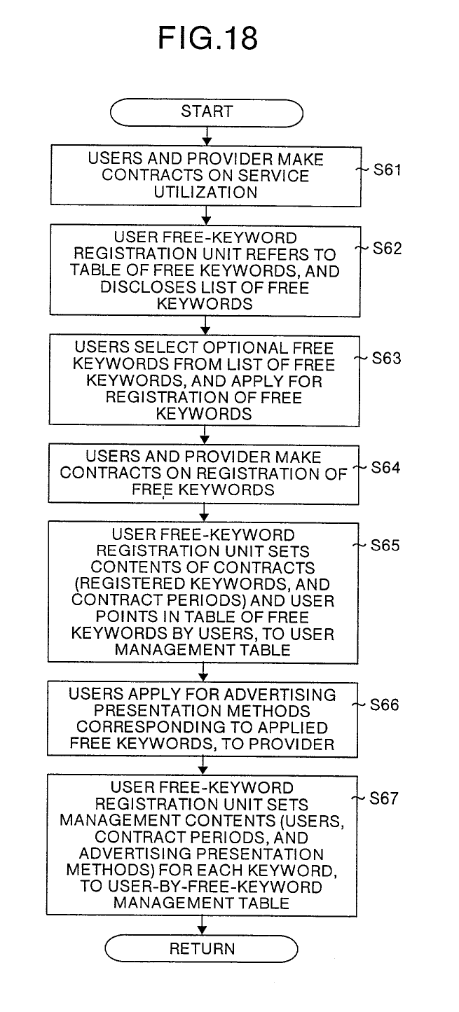

FIG. 18 is a flowchart for explaining the free-keyword registration processing for users by the user free-keyword registering unit 114.

In FIG. 18, first, at step S61, users and the provider make contracts on the service utilization.

Next, at step S62, the user free-keyword registering unit 114 refers to the table of free keywords 133, and discloses a list of free keywords.

Next, at step S63, the users select optional free keywords from the list of free keywords, and apply for the registration of the free keywords.

Next, at step S64, the users and the provider make contracts on the registration of free keywords.

Next, at step S65, the user free-keyword registering unit 114 sets the contents of the contracts (registered keywords, and contract periods) and user points in the table of free keywords 133 by users, to the user management table 139.

Next, at step S66, the users apply for advertising presentation methods corresponding to the applied free keywords, to the provider.

Next, at step S67, the user free-keyword registering unit 114 sets the management contents (users, contract periods, and advertising presentation methods) for each keyword, to the user-by-free-keyword management table 138.

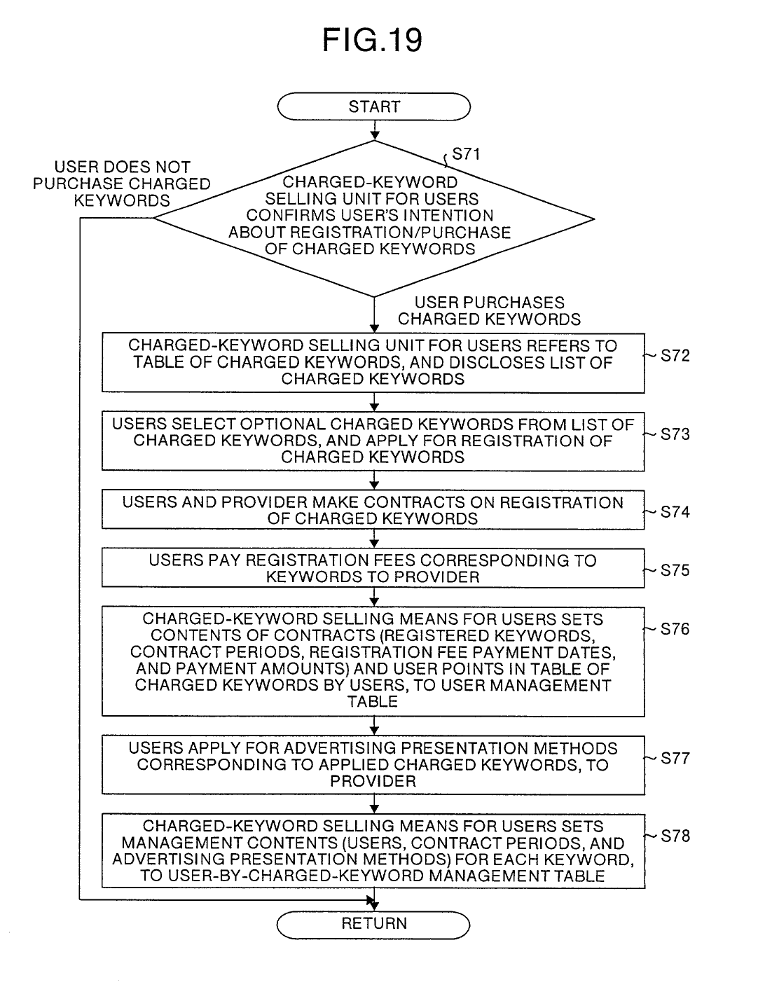

FIG. 19 is a flowchart for explaining the charged-keyword selling processing to users by the charged-keyword selling unit for users 115.

In FIG. 19, first, at step S71, the charged-keyword selling unit for users 115 confirms the user's intention about the registration/purchase of charged keywords. When the users do not purchase the charged keywords, the present processing finishes. When the users purchase the charged keywords, the process proceeds to step S72.

Next, at step S72, the charged-keyword selling unit for users 115 refers to the table of charged keywords 132, and discloses a list of charged keywords.

Next, at step S73, the users select optional charged keywords from the list of charged keywords, and apply for the registration of the charged keywords.

Next, at step S74, the users and the provider make contracts on the registration of charged keywords.

Next, at step S75, the users pay registration fees corresponding to the keywords to the provider.

Next, at step S76, the charged-keyword selling unit for users 115 sets the contents of the contracts (registered keywords, contract periods, registration fee payment dates, and payment amounts) and user points in the table of charged keywords 132 by users, to the user management table 139.

Next, at step S77, the users apply for advertising presentation methods corresponding to the applied charged keywords, to the provider.

Next, at step S78, the charged-keyword selling unit for users 115 sets the management contents (users, contract periods, and advertising presentation methods) for each keyword, to the user-by-charged-keyword management table 137.

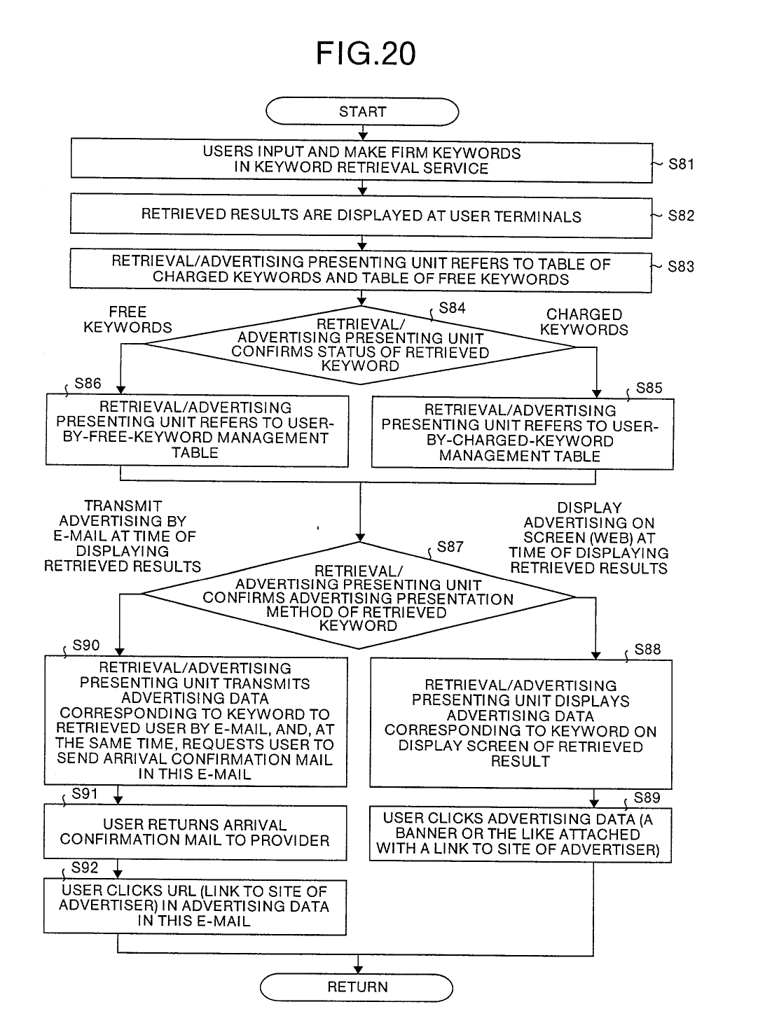

FIG. 20 is a flowchart for explaining the retrieval/advertising presentation processing by the retrieval/advertising presenting unit 116.

In FIG. 20, first, at step S81, users input and make firm keywords in the keyword retrieval service on the Internet.

Next, at step S82, retrieved results are displayed at user terminals.

Next, at step S83, the retrieval/advertising presenting unit 116 refers to the table of charged keywords 132 and the table of free keywords 133.

Next, at step S84, the retrieval/advertising presenting unit 116 confirms the status of a retrieved keyword. When a decision has been made that the retrieved keyword is a charged keyword, the process proceeds to step S85. The retrieval/advertising presenting unit 116 refers to the user-by-charged-keyword management table 137, and the process proceeds to step S87.

When a decision has been made at step S84 that the retrieved keyword is a free keyword, the process proceeds to step S86. The retrieval/advertising presenting unit 116 refers to the user-by-free-keyword management table 138, and the process proceeds to step S87.

Next, at step S87, the retrieval/advertising presenting unit 116 confirms an advertising presentation method of the retrieved keyword. When the screen display (Web) has been selected as the advertising presentation method of the retrieved result, the process proceeds to step S88.

At step S88, the retrieval/advertising presenting unit 116 displays the advertising data corresponding to the keyword on the display screen of the retrieved result.

Next, at step S89, the user clicks the advertising data (a banner or the like attached with a link to the site of an advertiser), and then, the present processing finishes.

When the e-mail has been selected as the advertising presentation method of the retrieved result at step S87, the process proceeds to step S90.

At step S90, the retrieval/advertising presenting unit 116 transmits advertising data corresponding to the keyword to the retrieved user by e-mail, and, at the same time, requests the user to send an arrival confirmation mail in this e-mail.

Next, at step S91, the user returns the arrival confirmation mail to the provider.

Next, at step S92, the user clicks the URL (the link to the site of the advertiser) in the advertising data in the e-mail. Then, the process finishes.

It is possible to omit the step S92 where the user clicks the URL of the advertiser site, by arranging such that the advertising contents described in the advertiser site are transmitted simultaneously when the advertising data is transmitted by e-mail at step S90.

At step S89 and step S92, the user clicks the URL or the banner or the like that is attached with a link to the advertiser site. It is possible to omit this operation. In this case, it is not possible to obtain the advertising points described later.

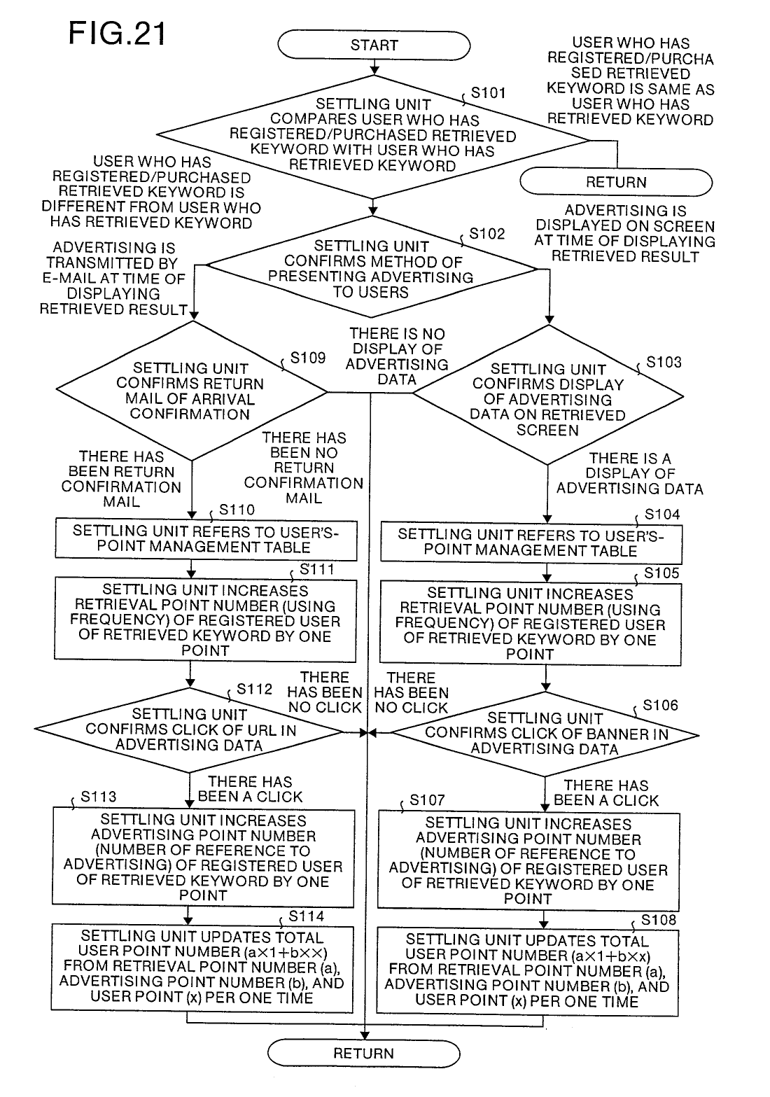

FIG. 21 is a flowchart for explaining the settlement processing by the settlement unit 117.

In FIG. 21, first, at step S101, the settlement unit 117 compares the user who has registered/purchased the retrieved keyword with a user who has retrieved the keyword. When the user who has registered/purchased the retrieved keyword is the same as the user who has retrieved the keyword, the present processing finishes. In other words, the user who has registered/purchased the retrieved keyword cannot obtain a user point for the user's own retrieval.

When the user who has registered/purchased the retrieved keyword is different from the user who has retrieved the keyword at step S101, the process proceeds to step S102.

Next, at step S102, the settlement unit 117 confirms a method of presenting advertising to the users. When the advertising is displayed on the screen at the time of displaying the retrieved result, the process proceeds to step S103.

At step S103, the settlement unit 117 confirms the presence/absence of a display of the advertising data on the retrieved screen. When there is a display of the advertising data on the retrieved screen, the process proceeds to step S104. When there is no display, the present processing finishes.

Next, at step S104, the settlement unit 117 refers to the user's-point management table 140.

Next, at step S105, the settlement unit 117 increases the retrieval point number (using frequency) of the registered user of the retrieved keyword by one point.

Next, at step S106, the settlement unit 117 confirms a click of the banner in the advertising data. When there has been a click, the process proceeds to step S107. When there has been no click, the present processing finishes.

Next, at step S107, the settlement unit 117 increases the advertising point number (number of reference to the advertising) of the registered user of the retrieved keyword by one point.

Next, at step S108, the settlement unit 117 updates the total user point number (a×1+b×x) from the retrieval point number (a), the advertising point number (b), and the user point (x) per one time. Then, the present processing finishes.

Next, when the advertising has been transmitted by e-mail at the time of displaying the retrieved result as a method of presenting the advertising to the users at step S102, the process proceeds to step S109.

Next, at step S109, the settlement unit 117 confirms the return mail of an arrival confirmation. When there has been a return confirmation mail, the process proceeds to step S110. When there has been no return mail, the present processing finishes.

At step S110, the settlement unit 117 refers to the user's-point management table 140.

At step S111, the settlement unit 117 increases the retrieval point number (using frequency) of the registered user of the retrieved keyword by one point.

Next, at step S112, the settlement unit 117 confirms a click of the URL in the advertising data. When there has been a click, the process proceeds to step S113. When there has been no click, the present processing finishes.

At step S113, the settlement unit 117 increases the advertising point number (number of reference to the advertising) of the registered user of the retrieved keyword by one point.

Next, at step S114, the settlement unit 117 updates the total user point number (a×1+b×x) from the retrieval point number (a), the advertising point number (b), and the user point (x) per one time.

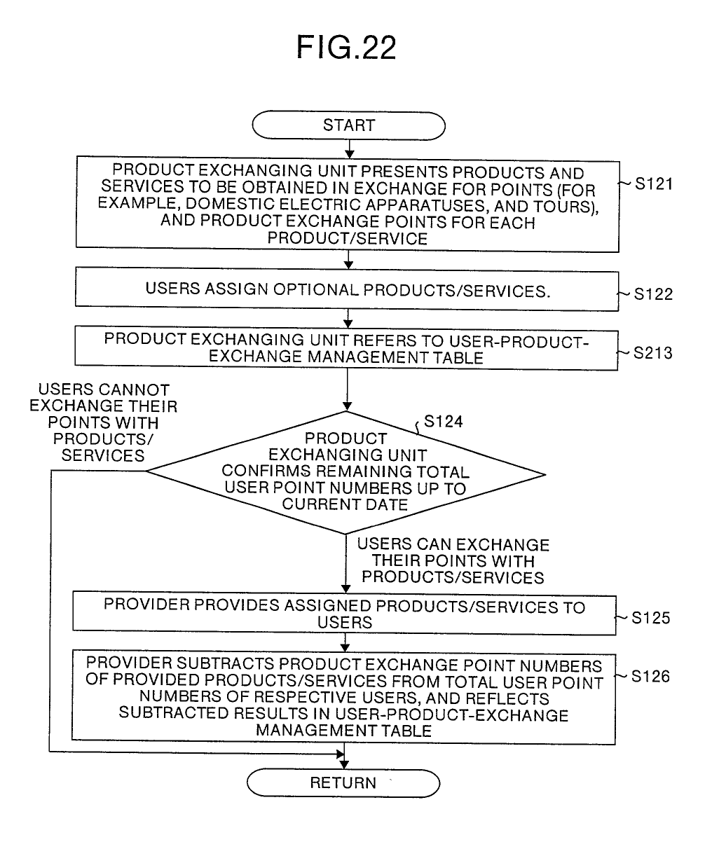

FIG. 22 is a flowchart for explaining the product exchange processing by the product exchanging unit 118.

In FIG. 22, first, at step S121, the product exchanging unit 118 presents products and services to be obtained in exchange for points (for example, domestic electric apparatuses, and tours), and product exchange points for each product/service.

Next, at step S122, users assign optional products/services.

Next, at step S123, the product exchanging unit 118 refers to the user-product-exchange management table 141.

Next, at step S124, the product exchanging unit 118 confirms the remaining total user point numbers up to the current date. When the users can exchange their points with products/services, the process proceeds to step S125. When the users cannot exchange their points with products/services because of small points or the like, the present processing finishes.

At step S125, the provider provides the assigned products/services to the users.

At step S126, the provider subtracts the product exchange point numbers of the provided products/services from the total user point numbers of the respective users, and reflects the subtracted results in the user-product-exchange management table 141.

When the users cannot exchange their points with products/services at step S124, the users can assign products/services again by going back to step S122. Before presenting the point numbers for exchange with products/service at step S121, the product exchanging unit 118 may present only products/services that can be obtained in exchange for the user's points by referring to the user-product-exchange management table 141.

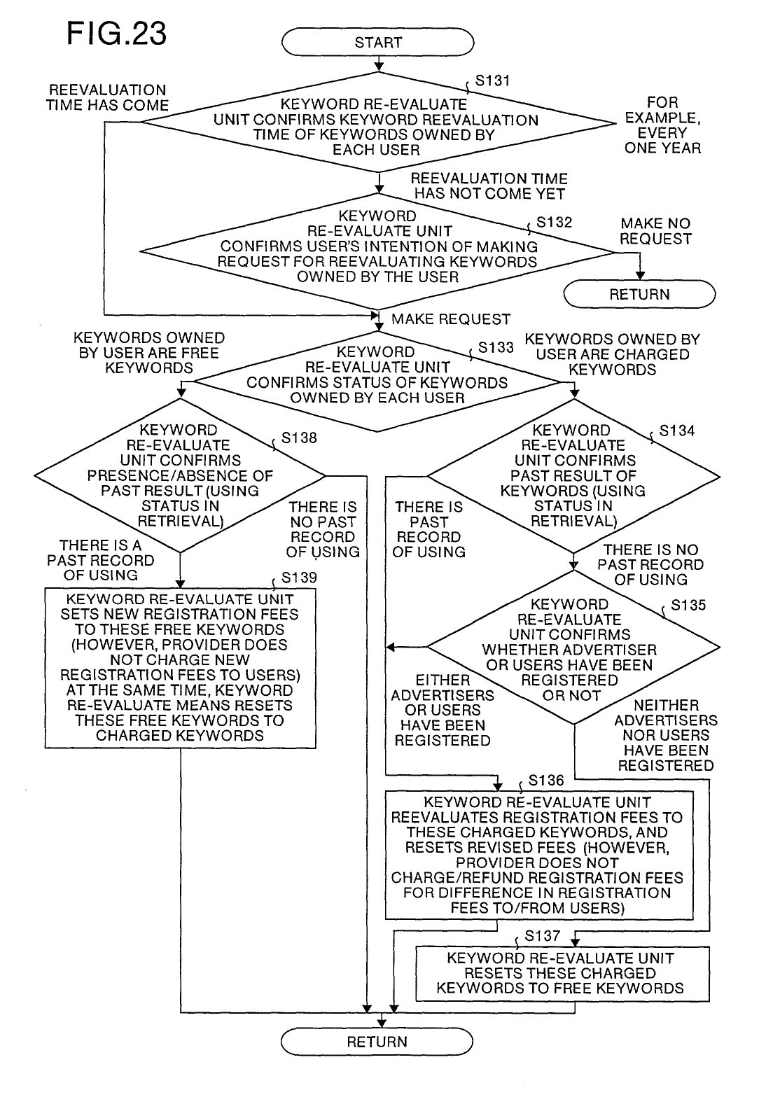

FIG. 23 is a flowchart for explaining the keyword reevaluation processing by the keyword re-evaluating unit 119.

In FIG. 23, first at step S131, the keyword re-evaluating unit 119 confirms whether a keyword re-evaluation time of keywords owned by each user has come or not. The evaluation may be carried out every one year, for example. When the re-evaluation time has not come yet, the process proceeds to step S132. When the re-evaluation time has already come, the process proceeds to step S133.

At step S132, the keyword re-evaluating unit 119 confirms the user's intention of making a request for re-evaluating the keywords owned by the user. When the user requests for the reevaluation, the process proceeds to step S133. When the user does not request for the re-evaluation, the present processing finishes.

At step S133, the keyword re-evaluating unit 119 confirms the status of the keywords owned by each user. When the keywords owned by the user are charged keywords, the process proceeds to step S134.

At step S134, the keyword re-evaluating unit 119 confirms the past result of the keywords (using status in the retrieval). When there is no past record of using, the process proceeds to step S135. When there is a past record of using, the process proceeds to step S136.

At step S135, the keyword re-evaluating unit 119 confirms whether advertiser or users have been registered or not. When either advertisers or users have been registered, the process proceeds to step S136.

At step S136, the keyword re-evaluating unit 119 re-evaluates the registration fees to these charged keywords, and resets revised fees. Then, the present processing finishes. However, the provider does not charge/refund the registration fees for the difference in the registration fees to/from the users.

When advertisers or users have not been registered at step S135, the process proceeds to step S137. The keyword re-evaluating unit 119 resets these charged keywords to free keywords. Then, the present processing finishes.

On the other hand, when the charged keywords have been decided as free keywords at step S133, the process proceeds to step S138.

At step S138, the keyword re-evaluating unit 119 confirms the presence/absence of past result (using status in the retrieval). When there is a past record of using, the process proceeds to step S139. When there is no past record of using, the present processing finishes.

At step S139, the keyword re-evaluating unit 119 sets new registration fees to these free keywords. At the same time, the keyword re-evaluating unit 119 resets these free keywords to charged keywords. Then, the present processing finishes. However, the provider does not charge new registration fees to the users.

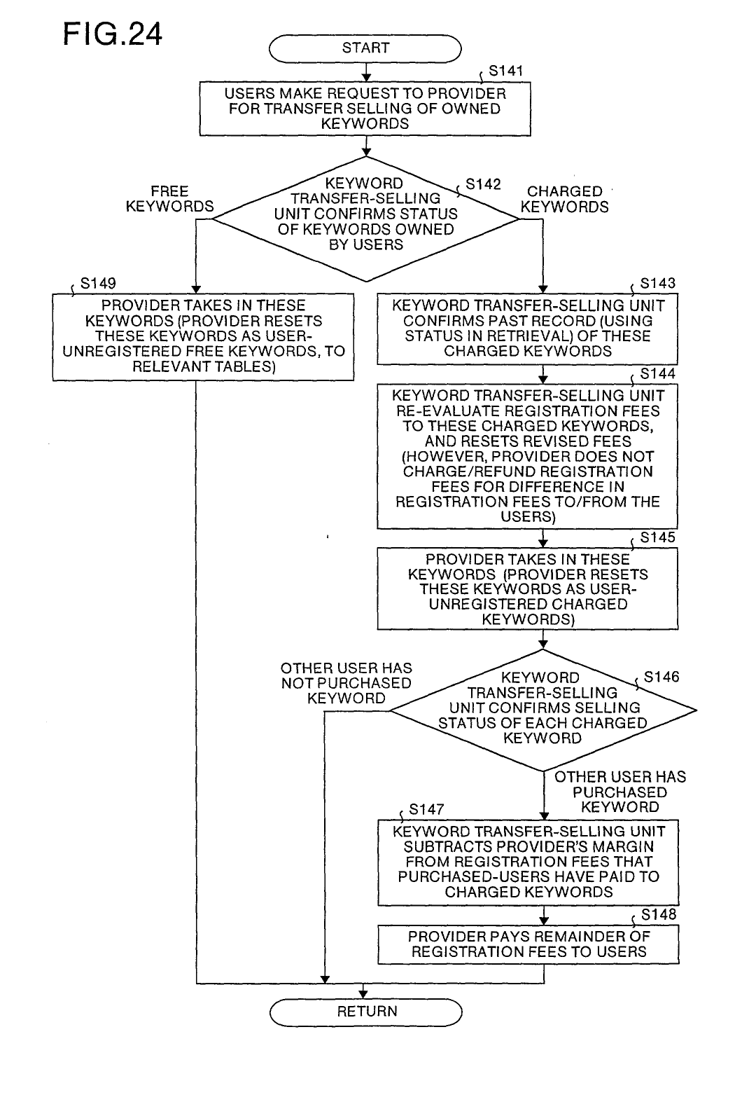

FIG. 24 is a flowchart for explaining the keyword transfer-selling by the keyword transfer-selling unit 120.

In FIG. 24, first at step S141, users make request to the provider for transfer selling of the owned keywords.

Next, at step S142, the keyword transfer-selling unit 120 confirms the status of the keywords owned by the users. When these keywords are charged keywords, the process proceeds to step S143.

At step S143, the keyword transfer-selling unit 120 confirms a past record (using status in the retrieval) of these charged keywords.

At step S144, the keyword transfer-selling unit 120 reevaluates the registration fees to these charged keywords, and resets revised fees. However, the provider does not charge/refund the registration fees for the difference in the registration fees to/from the users.

Next, at step S145, the provider takes in these keywords, and resets these keywords as user-unregistered charged keywords.

Next, at step S146, the keyword transfer-selling unit 120 confirms the selling status of each charged keyword. When other user has purchased the keyword, the process proceeds to step S147. When other users have not purchased the keywords, the present processing finishes.

At step S147, the keyword transfer-selling unit 120 subtracts the provider's margin (for example, 10%) from the registration fees that the purchased users have paid to these charged keywords.

At step S148, the provider pays the remainder (for example, 90%) of the registration fees after subtracting the provider's margin, to the users. Then, the present processing finishes.

On the other hand, when the user-owned keywords are free keywords at step S142, the process proceeds to step S149.

At step S149, the provider takes in these keywords, and resets these keywords as user-unregistered free keywords, to relevant tables.

The computer readable recording medium according to another aspect of the present invention stores a computer program which when executed realizes the method according to the present invention.

As explained above, according to the present invention, users who have obtained keywords can gain points when other users than these users have retrieved these keywords or referred to the advertising. Further, these keyword-obtained users can obtain products in exchange for their points. Thus, service providers can provide a user-participation type business system that involves end users. As a result, the service providers can further expand their services (business).

Further, according to the present invention, it is possible to register not only charged keywords but also free keywords. Therefore, it is possible to effectively use this system for promoting the conclusion of user service utilization contracts. This can further give incentive to the advertisers for their participation in this system (purchasing of charged keywords).

Although the invention has been described with respect to a specific embodiment for a complete and clear disclosure, the appended claims are not to be thus limited but are to be construed as embodying all modifications and alternative constructions that may occur to one skilled in the art which fairly fall within the basic teaching herein set forth.

What is claimed is:

1. A method of providing points based on a retrieval of keywords, the method comprising the steps of:
presenting keywords to a first user through a network, and storing keywords selected by the user into a user-by-keyword management table relating to the user;
presenting keywords to an advertiser through the network, and storing keywords selected by the advertiser into an advertiser-by-keyword management table relating to the advertiser;
searching the user-by-keyword management table and the advertiser-by-keyword management table for keywords when there has been a request for retrieving the keywords from a second user different from the first user through the network, and when the requested keywords have been registered both in the user-by-keyword management table and the advertiser-by-keyword management table, posting a retrieved result of the keywords and advertisement of the corresponding advertiser to the second user through the network; and
giving points to the first user when the second user has referred to the advertisement, and storing these points into a user's-point management table relating to the first user.

2. The method of providing points according to the claim 1, wherein the points gained by the users are exchanged for a product or a service.

3. The method of providing points according to the claim 1, wherein the points consist of user points that are generated when the other users have retrieved the user-obtained keywords and advertiser points that are generated when the other users have referred to the advertisement.

4. The method of providing points according to the claim 1, wherein the selection of the keywords is free of charge, and the users can select the free keywords at the time of making a contract on the utilization of a network service.

5. The method of providing points according to the claim 1, wherein the selection of the keywords is charged, and purchase prices of the charged keywords are determined based on a past record of retrieval of the keywords by the other users.

6. The method of providing points according to the claim 1, wherein the keywords selected by the users include charged keywords and free keywords, and charged keyword of which retrieval record by the other users is low are converted to free keywords, and free keywords of which retrieval record by the other users is high are converted to charged keywords.

7. The method of providing points according to the claim 1, wherein the keywords selected by the advertisers include charged keywords and free keywords, and the advertisers can select the free keywords only after the advertisers have selected the charged keywords.

8. The method of providing points according to the claim 1, wherein the users who have registered the keywords can select a display on the Web or a transmission by e-mail as a method of presenting the advertisement to the other users.

9. A method of providing points comprising the steps of:
obtaining keywords that a user can obtain from a server through a network, and displaying the obtained keywords at a user's terminal;
transmitting keywords that the user has selected from the user's terminal to the server;
presenting results of retrieval by other user together with advertisement of advertisers corresponding to the keywords registered in the server to the other user, when an another user different from the above user has retrieved the keywords through the network; and
giving points to the user who has obtained the keywords, when the other user has referred to the advertisement.

10. A method of providing points comprising the steps of:
obtaining keywords that an advertiser can obtain from a server through a network, and displaying the obtained keywords at advertiser's terminal;
transmitting keywords that the advertiser has selected from the advertiser's terminal to the server;
presenting results of retrieval of keywords by user together with advertisement of the advertiser to the user, when the user has retrieved the keywords; and
giving points to an another user who has obtained the keywords stored in the server, when the user who has retrieved the keywords have referred to the advertisement.

11. A method of providing points based on a retrieval of keywords, the method comprising the steps of:
displaying retrieved results of keywords together with advertisement of advertiser corresponding to the keywords at user's terminal, when the user has retrieved the keywords from the user's terminal through a network; and
giving points to an another user who has selected the keywords, when the keyword-retrieved user has referred to the displayed advertisement.

12. An apparatus for providing points, said apparatus comprising:
a user-selected keyword storing unit which stores keywords that a user has selected through a network, relating to the user;
an advertiser-selected keyword storing unit which stores keywords that an advertiser has selected through the network, relating to the advertiser;
an advertiser-retrieving unit which retrieves an advertiser corresponding to keywords by referring to an advertiser-by-keyword management table, when an another user different from the user who has retrieved through the network the keywords that have been registered in both a user-by-keyword management table and the advertiser-by-keyword management table;
a transmitting unit which transmits the retrieved results together with advertisement of the advertiser to the another user;
a user retrieving unit which retrieves the user corresponding to the keywords by referring to the user-by-keyword management table, when the another user has referred to the advertisement;
point allocating unit which gives points to the user who has obtained the keyword; and
point registering unit which registers the points by relating the points to the user.

13. A computer readable medium for storing instructions, which when executed on a computer, causes the computer to perform a method of providing points based on a retrieval of keywords, the method comprising the steps of:
presenting keywords to a first user through a network, and storing keywords selected by the user into a user-by-keyword management table relating to the user;
presenting keywords to an advertiser through the network, and storing keywords selected by the advertiser into an advertiser-by-keyword management table relating to the advertiser;
searching the user-by-keyword management table and the advertiser-by-keyword management table for keywords when there has been a request for retrieving the keywords from a second user different from the first user through the network, and when the requested keywords have been registered both in the user-by-keyword management table and the advertiser-by-keyword management table, posting a retrieved result of the keywords and advertisement of the corresponding advertiser to the second user through the network; and
giving points to the first user when the second user has referred to the advertisement, and storing these points into a user's-point management table relating to the first user.

14. A computer readable medium for storing instructions, which when executed on a computer, causes the computer to perform a method of providing points, the method comprising the steps of:
obtaining keywords that a user can obtain from a server through a network, and displaying the obtained keywords at a user's terminal;
transmitting keywords that the user has selected from the user's terminal to the server;
presenting results of retrieval by other user together with advertisement of advertisers corresponding to the keywords registered in the server to the other user, when an another user different from the above user has retrieved the keywords through the network; and
giving points to the user who has obtained the keywords, when the other user has referred to the advertisement.

15. A computer readable medium for storing instructions, which when executed on a computer, causes the computer to perform a method of providing points, the method comprising the steps of:
obtaining keywords that an advertiser can obtain from a server through a network, and displaying the obtained keywords at advertiser's terminal;
transmitting keywords that the advertiser has selected from the advertiser's terminal to the server;
presenting results of retrieval of keywords by user together with advertisement of the advertiser to the user, when the user has retrieved the keywords; and
giving points to an another user who has obtained the keywords stored in the server, when the user who has retrieved the keywords have referred to the advertisement.

16. A computer readable medium for storing instructions, which when executed on a computer, causes the computer to perform a method of providing points based on a retrieval of keywords, the method comprising the steps of:
displaying retrieved results of keywords together with advertisement of advertiser corresponding to the keywords at user's terminal, when the user has retrieved the keywords from the user's terminal through a network; and
giving points to an another user who has selected the keywords, when the keyword-retrieved user has referred to the displayed advertisement.

17. A computer program for causing the computer to perform a method of providing points based on a retrieval of keywords, the method comprising the steps of:
presenting keywords to a first user through a network, and storing keywords selected by the user into a user-by-keyword management table relating to the user;
presenting keywords to an advertiser through the network, and storing keywords selected by the advertiser into an advertiser-by-keyword management table relating to the advertiser;
searching the user-by-keyword management table and the advertiser-by-keyword management table for keywords when there has been a request for retrieving the keywords from a second user different from the first user through the network, and when the requested keywords have been registered both in the user-by-keyword management table and the advertiser-by-keyword management table, posting a retrieved result of the keywords and advertisement of the corresponding advertiser to the second user through the network; and
giving points to the first user when the second user has referred to the advertisement, and storing these points into a user's-point management table relating to the first user.

18. A computer program for causing the computer to perform a method of providing points, the method comprising the steps of:
obtaining keywords that a user can obtain from a server through a network, and displaying the obtained keywords at a user's terminal;
transmitting keywords that the user has selected from the user's terminal to the server;
presenting results of retrieval by other user together with advertisement of advertisers corresponding to the keywords registered in the server to the other user, when an another user different from the above user has retrieved the keywords through the network; and
giving points to the user who has obtained the keywords, when the other user has referred to the advertisement.

19. A computer program for causing the computer to perform a method of providing points, the method comprising the steps of:
obtaining keywords that an advertiser can obtain from a server through a network, and displaying the obtained keywords at advertiser's terminal;
transmitting keywords that the advertiser has selected from the advertiser's terminal to the server;
presenting results of retrieval of keywords by user together with advertisement of the advertiser to the user, when the user has retrieved the keywords; and
giving points to an another user who has obtained the keywords stored in the server, when the user who has retrieved the keywords have referred to the advertisement.

20. A computer program for causing the computer to perform a method of providing points based on a retrieval of keywords, the method comprising the steps of:
displaying retrieved results of keywords together with advertisement of advertiser corresponding to the keywords at user's terminal, when the user has retrieved the keywords from the user's terminal through a network; and
giving points to an another user who has selected the keywords, when the keyword-retrieved user has referred to the displayed advertisement.
